(19) United States
(12) Patent Application Publication
(10) Pub. No.: US 2026/0264017 A1
(43) Pub. Date: Sep. 10, 2026

(54) HYDROPHILIC NANOFILTRATION/ULTRAFILTRATION MEMBRANE AS A CO2 ABSORBER FOR AIR CAPTURE

(71) Applicant: University of Kentucky Research Foundation, Lexington, KY (US)

(72) Inventors: Jinwen Wang, Lexington, KY (US); Xin Gao, Lexington, KY (US); Ayokunle Omosebi, Lexington, KY (US); Kunlei Liu, Lexington, KY (US)

(21) Appl. No.: 19/557,947

(22) Filed: Mar. 5, 2026

Related U.S. Application Data
(60) Provisional application No. 63/767,396, filed on Mar. 5, 2025.

(51) Int. Cl. B01D 53/96; B01D 53/14; B01D 53/18; B01D 53/62; B01D 53/78; B01D 61/02; B01D 69/04; C25B 1/04

(52) U.S. Cl. CPC B01D 53/965; B01D 53/1425; B01D 53/1475; B01D 53/1493; B01D 53/185; B01D 53/62; B01D 53/78; B01D 61/027; B01D 69/04; B01D 2251/306; B01D 2251/604; B01D 2257/504; B01D 2258/06; C25B 1/04

(57) ABSTRACT

An apparatus, for capturing carbon dioxide from a gas stream, includes: (a) a combined carbon dioxide absorbent and electrolyte, (b) a membrane chamber including a hydrophilic nanofiltration membrane adapted to act as a carbon dioxide absorber whereby upon contact, carbon dioxide from the gas stream reacts with the combined carbon dioxide absorbent and electrolyte, and (c) an electrochemical regenerator adapted to release captured carbon dioxide and regenerate the combined carbon dioxide absorbent and electrolyte. The apparatus is useful in a method of capturing carbon dioxide from a gas stream such as directly from the air.

### RELATED APPLICATION

This application claims priority to US Provisional Patent Application Serial No. 63/767,396, filed on Mar. 5, 2025, hereby incorporated by reference.

### GOVERNMENT SUPPORT

This invention was made with government support under Grant No. DE-FE0032125 awarded by the Department of Energy. The government has certain rights in the invention.

### TECHNICAL FIELD

This document relates generally to solvent-based carbon dioxide (CO₂) capture systems and related methods and, more particularly to such a system and method using a hydrophilic nanofiltration/ultrafiltration (NF/HF) membrane.

### BACKGROUND

The traditional approach to CO₂ capture typically involves random or structured packing in absorption columns, where a solvent is used to absorb CO₂ from the gas phase. While effective, these systems often suffer from limitations in gas-liquid contact areas, dry packing surface, leading to inefficiencies in mass transfer, particularly when operated at low liquid to gas ratio.

In an alternative approach, conventional membrane contactors utilize hydrophobic membranes made from materials such as polytetrafluorethylene (PTFE) or polypropylene (PP). While these systems are effective in some applications, they frequently suffer from wetting issues during long-term operation, leading to reduced efficiency and shortened lifespan. Additionally, traditional contactors generally have limited gas-liquid contact surfaces, which diminishes their CO₂ capture efficiency.

This invention differentiates itself by using a hydrophilic NF/UF membrane, which completely eliminates wetting issues and significantly enhances the mass transfer process. The NF membrane generates nano-sized liquid droplets, drastically improving the surface area available for gas-liquid contact, thereby leading to higher CO₂ capture efficiency.

Moreover, the NF membrane has the capability to selectively separate OH⁻ and CO₃²⁻ ions, reducing the energy demands when used in combination with the electrochemical regenerator. This further enhances the system’s overall efficiency and reduces operational costs compared to conventional direct air capture (DAC) systems. Various commercial selective membrane materials can be modified slightly to coat on a tube form support to develop the corresponding NF membranes as a tube form which will possess a higher selectivity of OH-/CO₃²⁻ than the current NX capillary membrane.

This document discloses a novel solvent-based CO₂ capture system that integrates a hydrophilic nanofiltration (NF) membrane acting as a CO₂ absorber, coupled with an electrochemical regenerator for enhanced efficiency. Unlike conventional packed-bed or spray tower absorbers, this system leverages a unique membrane design that utilizes an OH⁻-selective hydrophilic NF membrane instead of the typical hydrophobic membranes and uses a tubular membrane with a large inside diameter (in the range of 0.5-2mm).

The NF membrane serves a triple purpose as a nanofiltration medium, a liquid microdroplet distributor, and a gas-liquid contact surface. This unique configuration eliminates wetting issues commonly encountered in traditional membrane contactors using hydrophobic material, and the dry packing surface for conventional structure packing operated at low liquid loading.

The membrane absorber enables CO₂ capture by creating a contact between the solvent (KOH) and gas on the fine tubular surface. The captured CO₂ reacts to form potassium carbonate (K₂CO₃), which is then processed in an electrochemical regenerator (ER). In the regenerator, CO₂ and O₂ gases are released, and the potassium hydroxide (KOH) is regenerated. This inorganic solvent system demonstrates consistent performance in direct air capture, achieving over 90% capture efficiency at air flow rates of cubic feet per minute (CFM) scale.

### SUMMARY

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of”.

As used herein, “substantially” is meant to permit deviations from the descriptive term that don’t negatively impact the intended purpose. Descriptive terms are implicitly understood to be modified by the word substantially, even if the term is not explicitly modified by the word substantially.

As used herein, the singular forms “a,” “an” and “the” include plural referents unless the context clearly dictates otherwise.

As used herein, “about,” “approximate,” “at or about,” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

In accordance with the purposes and benefits set forth herein, a new and improved apparatus for capturing carbon dioxide from a gas stream, comprises, consists of or consists essentially of:
(a) a combined carbon dioxide absorbent and electrolyte;
(b) a membrane chamber including a hydrophilic nanofiltration membrane adapted to act as a carbon dioxide absorber whereby upon contact, carbon dioxide from the gas stream reacts with the combined carbon dioxide absorbent and electrolyte; and
(c) an electrochemical regenerator adapted to release captured carbon dioxide and regenerate the combined carbon dioxide absorbent and electrolyte.

In at least some of the many possible embodiments, the combined carbon dioxide absorbent and electrolyte is an aqueous solution of a metal hydroxide. In some embodiments, the combined carbon dioxide absorbent and electrolyte is aqueous potassium hydroxide which reacts with the carbon dioxide removed from the gas stream to produce aqueous potassium carbonate or potassium bicarbonate.

The hydrophilic nanofiltration membrane may be adapted for selective separation of hydroxide ions and carbonate ions. The hydrophilic nanofiltration membrane may be in the shape of an elongated tube having a lumen and the gas stream may pass through the lumen. The hydrophilic nanofiltration membrane may have a lumen diameter of about 0.5 mm to about 2.0 mm, or higher.

The electrochemical regenerator may include a first electrochemical cell having a first cathode chamber and a first anode chamber separated by a first cation exchange membrane. The first cathode chamber may include a first cathode, a first cathode chamber inlet and a first cathode chamber outlet. The first anode chamber may include a first anode, a first anode chamber inlet and a first anode chamber outlet. The electrochemical regenerator may further include a second electrochemical cell having a second cathode chamber and a second anode chamber separated by a second cation exchange membrane. The second cathode chamber may include a second cathode, a second cathode chamber inlet in communication with the first cathode chamber outlet and a second cathode chamber outlet. The second anode chamber may include a second anode chamber inlet in communication with the first anode chamber outlet and a second anode chamber outlet.

In at least some embodiments, the apparatus further includes a cathodic gas-liquid separator between the first cathode outlet and the second cathode inlet. The cathodic gas-liquid separator may be adapted for one or more of the following: (a) separating hydrogen, generated at the first cathode, from the combined carbon dioxide absorbent and electrolyte received from the first cathode chamber, (b) delivering the separated hydrogen to the second anode chamber, and (c) delivering the combined carbon dioxide absorbent received from the first cathode chamber, minus the hydrogen, to the second cathode chamber.

In at least some embodiments, the apparatus further includes an anodic gas-liquid separator between the first anode chamber outlet and the second anode chamber inlet. The anodic gas-liquid separator may be adapted for one or more of the following: (a) separating any gas, generated at the first anode, from the combined carbon dioxide absorbent and electrolyte received from the first anode chamber, (b) delivering the combined carbon dioxide absorbent received from the first anode chamber, minus the gas, to the second anode chamber, and (c) discharging the separated gas outside the second anode chamber.

In one or more of the many possible embodiments, a pH of the combined carbon dioxide absorbent and electrolyte in the first anode chamber is maintained above a predetermined value to convert potassium carbonate in the combined carbon dioxide absorbent and electrolyte to potassium bicarbonate and generate only oxygen gas at the first anode so that all of the carbon dioxide previously captured in the combined carbon dioxide absorbent and electrolyte is released at the second anode and exhausted through the second anode compartment outlet.

In at least some embodiments, the apparatus further includes a gas-liquid separator between the membrane chamber and the electrochemical regenerator to provide a sump for the combined carbon dioxide absorbent and electrolyte.

In accordance with yet another aspect, a method of capturing carbon dioxide from a gas stream, comprises, consists of or consists essentially of:
(a) absorbing carbon dioxide from a gas stream using a hydrophilic nanofiltration membrane by creating contact between the carbon dioxide and a combined carbon dioxide absorbent and electrolyte in a membrane chamber;
(b) reacting the carbon dioxide with hydroxide ions in the combined carbon dioxide absorbent and electrolyte to create carbonate ions in the solvent; and
(c) subsequently regenerating the hydroxide ions from the carbonate ions and releasing carbon dioxide.

The method may further include passing the gas stream through a lumen of the hydrophilic nanofiltration membrane while circulating the combined carbon dioxide absorbent and electrolyte around the hydrophilic nanofiltration membrane.

The subsequent regenerating of the hydroxide ions may also include (a) generating hydrogen at a first cathode in a first electrochemical cell and (b) converting carbonate ions to bicarbonate ions while generating oxygen at a first anode also in the first electrochemical cell. The subsequent regenerating of the hydroxide ions further includes (a) collecting and delivering the hydrogen generated at the first cathode in the first electrochemical cell to a second anode in an anode chamber of a second electrochemical cell and (b) delivering the combined carbon dioxide absorbent and electrolyte, minus the hydrogen, from a first cathode chamber in the first electrochemical cell to a second cathode chamber in the second electrochemical cell.

Still further, the subsequent regenerating of the hydroxide ions may include delivering the combined carbon dioxide absorbent and electrolyte from a first anode chamber of the first electrochemical cell, minus the oxygen, to the second anode chamber of the second electrochemical cell.

In at least some embodiments, the method includes maintaining pH of the combined carbon dioxide absorbent and electrolyte in the first anode chamber of the first electrochemical cell at a predetermined level in order to convert the potassium carbonate ions in the combined carbon dioxide absorbent and electrolyte to the potassium bicarbonate ions and generate only the oxygen gas at the first anode so that all of the carbon dioxide previously captured in the combined carbon dioxide absorbent and electrolyte is released at the second anode.

In at least some embodiments, the method further includes recirculating bicarbonate ions between the first and second anode chambers of the first and second electrochemical cells and recirculating hydroxide ions between the first and second cathode chamber of the first and second electrochemical cells. The method may also include recycling regenerated aqueous potassium hydroxide from the second cathode compartment of the second electrochemical cell to the membrane chamber.

Other systems, methods, features, and advantages of the present disclosure will be or become apparent to one with skill in the art upon examination of the following drawing and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWING FIGURE

Many aspects of the present disclosure can be better understood with reference to the following drawing figure. The components in the drawing figure are not necessarily to scale, emphasis instead being placed upon clearly illustrating the principles of the present disclosure.

FIG. 1 is a schematic illustration of the apparatus or system for capturing carbon dioxide from a gas stream.

### DETAILED DESCRIPTION

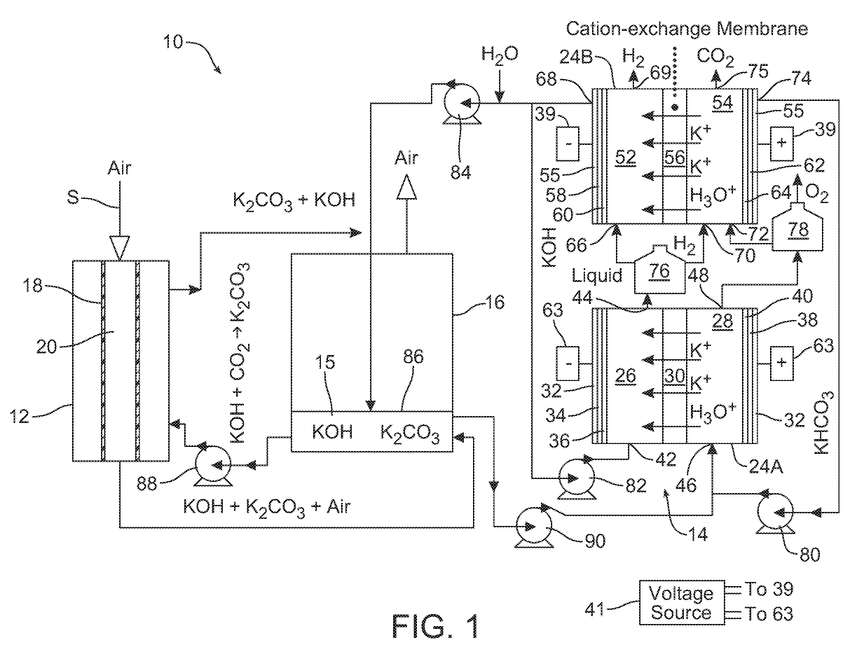

Reference is now made to FIG. 1 providing a schematic illustration of the new and improved apparatus 10 for capturing carbon dioxide from a gas stream. The apparatus 10 includes a membrane absorber permeate chamber 12, an electrochemical regenerator 14, and a drum gas-liquid separator 16 that interconnects the membrane chamber and the electrochemical regenerator and acts as a central fluid reservoir 86 for the solvent 15. The membrane chamber 12 includes a hydrophilic nanofiltration membrane 18, adapted to act as a carbon dioxide absorber. More specifically, the membrane 18 is OH⁻ selective and adapted for selective separation of hydroxide ions and carbonate ions.

In the illustrated embodiment, the membrane 18 is in the shape of an elongated tube having a lumen 20. As shown, the gas or air stream S to be processed to remove carbon dioxide passes through the lumen 20. The lumen 20 may have, for example, an internal diameter of about 0.5 mm to about 2.0 mm. While only one membrane 18 is shown in the membrane chamber 12 of the illustrated embodiment, other embodiments could include more than one membrane in parallel for processing of the gas stream S. In some embodiments, the arrangement is reversed with the combined carbon dioxide absorbent and electrolyte 15 passing through the lumen 20 and the gas stream 20 passing around the outside of the tubular membrane 18.

The membrane 18 functions to capture carbon dioxide from the gas/air stream S by creating on its surface contact and reaction between the carbon dioxide and a solvent 15 (in the form of a combined carbon dioxide absorbent and electrolyte), circulated through the membrane chamber 12 around the outer surface of the membrane. In one particularly useful embodiment, the solvent is potassium hydroxide (KOH) based and the reaction product generated by the reaction of the carbon dioxide with the potassium hydroxide is potassium carbonate (K₂CO₃). The solvent, at the membrane chamber 12, may comprise about 0.1M potassium hydroxide and about 1.0M potassium carbonate. In other possible embodiments, the combined carbon dioxide absorbent and electrolyte comprises different metal hydroxide or combinations of metal hydroxides.

In one possible embodiment, the membrane 18 comprises a capillary nanofiltration membrane module (NX Filtration WMC110 dNF40) with a surface area of 5.5 m². In other embodiments, the membrane 18 may comprise flat-sheet, hollow fiber, tubular, or spiral-wound polymer/metal/ceramic membrane. It should be appreciated that these membrane examples are merely illustrative in nature and not limiting in scope.

As will be explained below, the electrochemical regenerator 14 is adapted to release captured carbon dioxide from the reaction product: that is, regenerate potassium hydroxide from the potassium carbonate in the solvent. In the illustrated embodiment, the electrochemical regenerator 14 includes a first cell 24A and a second cell 24B, the two cells being in parallel. The primary function of both cells 24A, 24B is to convert potassium carbonate to potassium hydroxide and release carbon dioxide with hydrogen as a co-product. In the specific configuration illustrated in FIG. 1, cell 24A operates as a standard electrochemical regenerator cell producing hydrogen while cell 24B operates as a depolarized electrochemical regenerator cell that consumes that hydrogen to save energy.

The first cell 24A has a first cathode chamber 26 and a first anode chamber 28 separated by a first cation exchange membrane 30. The chambers 26 and 28 are enclosed by two stainless steel endplates 32. The first cation exchange membrane 30 may comprise a Solvay Aquivion^{®} PFSA E98-15R membrane, a Nafion^{®} membrane, such as a Nafion^{®}117, or the like.

A first cathode 34 is positioned in the first cathode chamber 26. The cathode 34 may comprise nickel, stainless steel or platinum, etc. The cathode 34 may also be associated with a current collector 36, such as a thin titanium plate. A first anode 38 is positioned in the first anode chamber 28. The anode 38 may comprise a Dimensionally Stable Anode (DSA^{®}), specifically a ruthenium /iridium-coated titanium mesh, which demonstrates superior oxygen evolution reaction catalysis. The anode 38 may also be associated with a current collector 40, such as a thin titanium plate. The first cathode 34 and the first anode 38 are connected at the terminals 63 to a voltage source 41.

As shown, the first cathode chamber 26 includes a first cathode compartment inlet 42 and a first cathode compartment outlet 44. The first anode chamber 28 includes a first anode compartment inlet 46 and a first anode compartment outlet 48.

As further illustrated in FIG. 1, the second cell 24B has a second cathode chamber 52 and a second anode chamber 54 separated by a second cation exchange membrane 56 just like the first cation exchange membrane 30. The chambers 52 and 54 are enclosed by two stainless steel endplates 55.

A second cathode 58 is positioned in the second cathode chamber 52. The cathode 58 may comprise nickel, stainless steel or platinum, etc. The cathode 58 may also be associated with a current collector 60, such as a thin titanium plate. A second anode 62 is positioned in the second anode chamber 54. The anode 62 may comprise a Dimensionally Stable Anode (DSA^{®}), specifically a ruthenium /iridium-coated titanium mesh, which demonstrates superior oxygen evolution reaction catalysis. The anode 62 may also be associated with a current collector 64, such as a thin titanium plate. The second cathode 58 and the second anode 62 are connected at the terminals 39 to the voltage source 41. Voltage source 41 may comprise a single voltage source connected to both sets of terminals 39, 63 or two cooperating and independently adjustable voltage sources, with one voltage source connected to each set of terminals.

The second cathode chamber 52 includes a second cathode chamber inlet 66, a second cathode chamber outlet 68, and a gas discharge outlet 69. The second anode chamber 54 includes a first, second anode compartment inlet 70, a second, second anode compartment inlet 72, a second anode compartment outlet 74, and a gas discharge outlet 75.

The first cathode compartment outlet 44 from the first cathode chamber 26 is connected to a cathodic gas-liquid separator 76 adapted to separate the aqueous potassium hydroxide solvent from high purity hydrogen gas generated at the first cathode 34. The liquid solvent is then delivered from the separator 76 to the second cathode chamber 52 through the inlet 66 while the hydrogen gas is delivered to the second anode chamber 54 through the inlet 70. Feeding this hydrogen gas into the anode compartment 54 achieves the “anodic depolarization”, which significantly lowers the operating voltage of the second cell 24B.

The first anode compartment outlet 48 delivers liquid analyte (the potassium carbonate/potassium bicarbonate solution) circulating through the anode chamber 28 and any gas generated at the anode 38 to the anodic gas-liquid separator 78. Since the system features tunable pH control, depending on operating parameters, the cell 24A can be driven to release a mixture of oxygen and carbon dioxide. Alternatively, it can operate in a two-stage mode where cell 24A drops the pH just enough (to ~9.0) to convert carbonate to bicarbonate without releasing CO₂. In this mode, pure O₂ (from water electrolysis) is the only gas generated at the anode 38. In the illustrated embodiment, only oxygen is generated at the anode 38. That oxygen is separated from the liquid anolyte in the separator 78 and exhausted to atmosphere while the liquid analyte continues to cell 24B, where hydrogen depolarization provides the final pH drop (to ~8.0) to exhaust pure carbon dioxide from the outlet 74.

The apparatus 10 described above and illustrated in FIG. 1 is useful in a method of capturing carbon dioxide from a gas stream S. That method includes absorbing carbon dioxide from a gas stream S using a hydrophilic nanofiltration membrane 18. This is done by creating contact between the carbon dioxide and the combined carbon dioxide absorbent and electrolyte 15 in the membrane chamber 12 and reacting the carbon dioxide with hydroxide ions to create carbonate ions. The method then regenerates the hydroxide ions from the carbonate ions, releasing carbon dioxide. This regeneration is accomplished by:
(a) generating hydrogen at the first cathode 34 in a first electrochemical cell 24A;
(b) converting carbonate ions to bicarbonate ions while generating oxygen at a first anode 38 in the first electrochemical cell;
(c) collecting and delivering the hydrogen generated at the first cathode in the first electrochemical cell to the second anode 62 in the anode chamber 54 of the second electrochemical cell 24B;
(d) delivering the combined carbon dioxide absorbent and electrolyte 15, minus the hydrogen, from the first cathode chamber 26 in the first electrochemical cell to the second cathode chamber 52 in the second electrochemical cell; and
(e) delivering the combined carbon dioxide absorbent and electrolyte from the first anode chamber 28 of the first electrochemical cell, minus the oxygen, to the second anode chamber 54 of the second electrochemical cell.

The method further including maintaining pH of the combined carbon dioxide absorbent and electrolyte in the first anode chamber 28 of the first electrochemical cell 24A at a predetermined level in order to convert the potassium carbonate ions in the combined carbon dioxide absorbent and electrolyte to the potassium bicarbonate ions and generate only the oxygen gas at the first anode 38 so that all of the carbon dioxide previously captured in the combined carbon dioxide absorbent and electrolyte 15 is released at the second anode 62.

Still further, the method includes (a) recirculating an analyte portion of the combined adsorbent and electrolyte 15 with bicarbonate ions in between the first and second anode chambers 28, 54 of the first and second electrochemical cells 24A and 24B by means of the pump 80 and (b) recirculating a catholyte portion of the combined adsorbent and electrolyte (hydroxide ions) between the first and second cathode chambers 26, 52 of the first and second electrochemical cells by means of the pump 82. Still further, the method includes recycling regenerated aqueous potassium hydroxide from the second cathode compartment 52 of the second electrochemical cell 24B to the membrane chamber 12 by means of the pump 84. In the illustrated embodiment, this is done indirectly through the combined adsorbent and electrolyte reservoir 86 at the bottom of the gas-liquid separator 16 by the pump 88.

During operation, the CO₂-rich K₂CO₃ solution from the NF/UF membrane chamber 12 is routed into the gas-liquid separator 16, from which it is continuously fed by pump 90 to the first anode chamber 28 of the first cell 24A. Meanwhile, a first portion of the regenerated KOH (the catholyte) from the second cathode chamber 52 of the second cell 24B is pumped by pump 84 directly back into the gas-liquid separator 16 while a second portion is recirculated by the pump 82 to the first cathode chamber 26 through the inlet 42. The membrane absorber chamber 12 draws its feed directly from the shared solvent reservoir 86 in the separator 16. Within the cells 24A, 24B of the electrochemical regenerator 14, potassium ions (K⁺) transport across the cationic exchange membranes 30, 56 from the anode compartments 28, 54 to the cathode compartments 26, 52. Alternatively, this flow can be revised for commercial optimization; for example, the regenerated KOH can be dosed directly into the feed line instead of the separator 16 to maximize system efficiency.

The electrochemical regenerator 14 induces a pH swing to drive the separation. For effective CO₂ release, the anode pH must be driven down below the pKₐ₂ of 10.3. To maximize the CO₂ release rate, the system cycles the anode pH down through the typical carbonate/bicarbonate buffer range (around pH 8.2–8.3) and into lower values. This targeted drop actively facilitates the conversion of the bicarbonate intermediate into carbonic acid and dissolved CO₂. Concurrently, the cathode pH is maintained at approximately 13 or above to effectively regenerate the KOH and maintain the absorber’s performance.

Advantageously, the cells 24A, 24B can operate over a robust range of current densities. While nominal testing was performed at 35 mA/cm², the system utilizing the DSA® electrode demonstrates highly efficient stabilized operating voltages even at higher current densities up to hundreds mA/cm². When parallel cells 24A and 24B are utilized as illustrated in FIG. 1, the hydrogen generated by the first cell 24A can be separated and routed to the anode compartment 54 of the second cell 24B for depolarization to further reduce the operating voltage. Thus, it should be appreciated that the current densities for operation of the two cells 24A, 24B may be controlled independently with the voltage source 41. More specifically, the current density of the depolarized cell 24B can be adjusted and optimized based upon the exact amount of hydrogen supplied by the cell 24A to maximize overall system savings and carbon dioxide release rates.

Numerous benefits result from employing the concepts disclosed in this document. The novel solvent-based CO₂ capture system integrates a hydrophilic nanofiltration (NF) membrane 18, acting as a CO₂ absorber, coupled with an electrochemical regenerator 14 for enhanced efficiency. Unlike conventional packed-bed or spray tower absorbers, this system 10 leverages a unique membrane design that utilizes an OH⁻-selective hydrophilic NF membrane instead of the typical hydrophobic membranes and uses a tubular membrane with a lumen 20 having a large inside diameter (in the range of 0.5-2mm).

The NF membrane 18 serves a triple purpose as a nanofiltration medium, a liquid microdroplet distributor, and a gas-liquid contact surface. This unique configuration eliminates wetting issues commonly encountered in traditional membrane contactors using hydrophobic material, and the dry packing surface for conventional structure packing operated at low liquid loading.

The membrane 18 enables CO₂ capture by creating a contact between the solvent (KOH) and gas on the fine tubular surface. The captured CO₂ reacts to form potassium carbonate (K₂CO₃), which is then processed in the electrochemical regenerator 14. In the regenerator 14, CO₂ and O₂ gases are released, and the potassium hydroxide (KOH) is regenerated. This inorganic solvent system demonstrates consistent performance in direct air capture (DAC), achieving over 90% capture efficiency at air flow rates of cubic feet per minute (CFM) scale.

Although the apparatus and method of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed is:

1. An apparatus for capturing carbon dioxide from a gas stream, comprising:
a combined carbon dioxide absorbent and electrolyte;
a membrane chamber including a hydrophilic nanofiltration membrane adapted to act as a carbon dioxide absorber whereby upon contact, carbon dioxide from the gas stream reacts with the combined carbon dioxide absorbent and electrolyte; and
an electrochemical regenerator adapted to release captured carbon dioxide and regenerate the combined carbon dioxide absorbent and electrolyte.

2. The apparatus of claim 1, wherein the combined carbon dioxide absorbent and electrolyte is an aqueous solution of a metal hydroxide.

3. The apparatus of claim 2, wherein the combined carbon dioxide absorbent and electrolyte is aqueous potassium hydroxide which reacts with the carbon dioxide removed from the gas stream to produce aqueous potassium carbonate.

4. The apparatus of claim 1, wherein the hydrophilic nanofiltration membrane is adapted for selective separation of hydroxide ions and carbonate ions.

5. The apparatus of claim 4, wherein the hydrophilic nanofiltration membrane is in the shape of an elongated tube having a lumen and the gas stream passes through the lumen.

6. The apparatus of claim 5, wherein the hydrophilic nanofiltration membrane has a lumen diameter of about 0.5mm to about 2.0mm.

7. The apparatus of claim 1, wherein the electrochemical regenerator includes a first electrochemical cell having a first cathode chamber and a first anode chamber separated by a first cation exchange membrane, (a) the first cathode chamber including a first cathode, a first cathode chamber inlet and a first cathode chamber outlet and (b) the first anode chamber including a first anode, a first anode chamber inlet and a first anode chamber outlet.

8. The apparatus of claim 7, wherein the electrochemical regenerator further includes a second electrochemical cell having a second cathode chamber and a second anode chamber separated by a second cation exchange membrane, (a) the second cathode chamber including a second cathode, a second cathode chamber inlet in communication with the first cathode chamber outlet and a second cathode chamber outlet and (b) the second anode chamber including a second anode chamber inlet in communication with the first anode chamber outlet and a second anode chamber outlet.

9. The apparatus of claim 8, further including a cathodic gas-liquid separator between the first cathode outlet and the second cathode inlet, the first gas-liquid separator being adapted for (a) separating hydrogen, generated at the first cathode, from the combined carbon dioxide absorbent and electrolyte received from the first cathode chamber, (b) delivering the separated hydrogen to the second anode chamber, and (c) delivering the combined carbon dioxide absorbent received from the first cathode chamber, minus the hydrogen, to the second cathode chamber.

10. The apparatus of claim 9, further including an anodic gas-liquid separator between the first anode chamber outlet and the second anode chamber inlet, the second gas-liquid separator being adapted for (a) separating any gas, generated at the first anode, from the combined carbon dioxide absorbent and electrolyte received from the first anode chamber, (b) delivering the combined carbon dioxide absorbent received from the first anode chamber, minus the gas, to the second anode chamber, and (c) discharging the separated gas outside the second anode chamber.

11. The apparatus of claim 10 wherein a pH of the combined carbon dioxide absorbent and electrolyte in the first anode chamber is maintained above a predetermined value to convert potassium carbonate in the combined carbon dioxide absorbent and electrolyte to potassium bicarbonate and generate only oxygen gas at the first anode so that all of the carbon dioxide previously captured in the combined carbon dioxide absorbent and electrolyte is released at the second anode and exhausted through the second anode compartment outlet.

12. The apparatus of claim 1, further including a gas-liquid separator between the membrane chamber and the electrochemical regenerator to provide a sump for the combined carbon dioxide absorbent and electrolyte.

13. A method of capturing carbon dioxide from a gas stream, comprising:
absorbing carbon dioxide from a gas stream using a hydrophilic nanofiltration membrane by creating contact between the carbon dioxide and a combined carbon dioxide absorbent and electrolyte in a membrane chamber;
reacting the carbon dioxide with hydroxide ions in the combined carbon dioxide absorbent and electrolyte to create carbonate ions in the solvent; and
subsequently regenerating the hydroxide ions from the carbonate ions and releasing carbon dioxide.

14. The method of claim 13, further including passing the gas stream through a lumen of the hydrophilic nanofiltration membrane while circulating the combined carbon dioxide absorbent and electrolyte around the hydrophilic nanofiltration membrane.

15. The method of claim 13, wherein the subsequent regenerating of the hydroxide ions includes (a) generating hydrogen at a first cathode in a first electrochemical cell and (b) converting carbonate ions to bicarbonate ions while generating oxygen at a first anode in the first electrochemical cell.

16. The method of claim 15, wherein the subsequent regenerating of the hydroxide ions further includes (a) collecting and delivering the hydrogen generated at the first cathode in the first electrochemical cell to a second anode in an anode chamber of a second electrochemical cell and (b) delivering the combined carbon dioxide absorbent and electrolyte, minus the hydrogen, from a first cathode chamber in the first electrochemical cell to a second cathode chamber in the second electrochemical cell.

17. The method of claim 16, wherein the subsequent regenerating of the hydroxide ions further includes delivering the combined carbon dioxide absorbent and electrolyte from a first anode chamber of the first electrochemical cell, minus the oxygen, to the second anode chamber of the second electrochemical cell.

18. The method of claim 17, further including maintaining pH of the combined carbon dioxide absorbent and electrolyte in the first anode chamber of the first electrochemical cell at a predetermined level in order to convert the potassium carbonate ions in the combined carbon dioxide absorbent and electrolyte to the potassium bicarbonate ions and generate only the oxygen gas at the first anode so that all of the carbon dioxide previously captured in the combined carbon dioxide absorbent and electrolyte is released at the second anode.

19. The method of claim 18, further including recirculating bicarbonate ions between the first and second anode chambers of the first and second electrochemical cells and recirculating hydroxide ions between the first and second cathode chamber of the first and second electrochemical cells.

20. The method of claim 19, further including recycling regenerated aqueous potassium hydroxide from the second cathode compartment of the second electrochemical cell to the membrane chamber.
